(19) United States
(12) Patent Application Publication
(10) Pub. No.: US 2018/0216950 A1
(43) Pub. Date: Aug. 2, 2018

(54) Platform for Rating and Sharing Route-Specific Data

(71) Applicant: Ford Global Technologies, LLC, Dearborn, MI (US)

(72) Inventors: Jamel Seagraves, Campbell, MI (US); Sudipto Aich, Palo Alto, CA (US); Chih-Wei Tang, Mountain View, CA (US); Yonathan Redda, Sunnyvale, CA (US)

(21) Appl. No.: 15/749,051

(22) PCT Filed: Aug. 6, 2015
(86) PCT No.: PCT/US2015/043969

§ 371 Date: Jan. 30, 2018

(51) Int. Cl. G01C 21/34; G01C 21/36; G06Q 50/00

(52) U.S. Cl. CPC G01C 21/3484; G06Q 50/01; G01C 21/3676

(57) ABSTRACT

The present disclosure extends to methods, systems, and computer program products for providing a socially based platform for rating routes of travel based on member user experience.

### RELATED APPLICATIONS

This application claims the benefit of PCT Application Serial No. PCT/US2015/043969, filed Aug. 6, 2015, which is hereby incorporated herein by reference in its entirety for all purposes.

### TECHNICAL FIELD

The disclosure relates generally to methods, systems, and computer program products for providing a social based platform for rating routes of travel based on member user experience.

### BACKGROUND

Bikes can provide a convenient, less costly and healthy mode of transportation. Existing routing solutions for bike routes and trails do not provide detailed information such as route safety, bike parking location, route descriptions, bike traffic, pedestrian versus rider density, route quality, bike-related incidents/accidents along the route, topography, air quality and other similar information. Bike riders rely on richer meta-data for routing and other relevant information during their ride than other types of commuters do and this is due to the inherent danger of cycling-verses-automobile scenarios.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1A illustrates an implementation of a social mobile application on a mobile electronic device to facilitate the rating of a route to a destination;

FIG. 1B illustrates an implementation of a social mobile application on a mobile electronic device to facilitate the selection of a route to a destination;

FIG. 2 is an illustration of an example computing environment in which techniques may be implemented in a mobile electronic device providing a social application to create a database of route characteristics from a community of users through the mobile electronic device to facilitate the selection of a route to a destination;

FIG. 3 illustrates a flow chart of an example method according to one implementation of the social application platform; and

FIG. 4 illustrates an example system for providing a social platform for rating routes by a community of users.

### DETAILED DESCRIPTION

The present disclosure extends to methods, systems, and computer program products for providing a route database with real time updates for bicycling routes that are used by members of a social community. The present disclosure also extends to methods, systems, and computer program products for allowing users to voluntarily provide information about the routes they travel or are currently traveling to create an up-to-date data base of route characteristics. Additionally, the present disclosure extends to providing route options to users of a social application based on the database of route characteristics, both historical characteristics and current characteristics in real time. The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

A social route rating platform may provide detailed bike route information that is accumulated over time and provided by expert cyclists, new cyclists, and tourists who will use the system both as information providers and information consumers. The social community members that will be information providers will be those members that provide route information to the social platform. It will be appreciated that the platform allows multiple users to share detailed information about particular routes. Information may include automobile specific information and bike-specific information, such as route safety, proximity to public transportation, bike parking locations, route descriptions, route traffic, route quality, accidents along the route, air quality, and the like. This information is used by automobile and bike riders to plan routes based on their particular needs and preferences. Also, the platform may use this information to prioritize route suggestions. The community members that will be information consumers are those members that will seek route information from the social platform that has been accumulated by the social route platform. The information collection and redistribution is designed to meet the needs of the full community of cyclists, both information providers and consumers equally. Automobile and bike riders may use this curated information to plan their rides in advance and select routes based on their individual needs.

It will be appreciated that the disclosure will use cycling and cycling specific information as an example implementation, but it should be noted that the disclosure is not limited to cycling. The disclosure applies equally to automobiles and automobile specific information as well as cycling specific information.

Cyclists can also input their experience as part of the social route rating platform, or in the least rate routes based on their experiences. Additionally, people who adopt cycling as a form of transportation regularly for their commute to work, or even recreational purposes, would benefit from a centralized route database kept up to date by an active online community.

The disclosed methods, features, systems, and computer program products will provide a computer based platform for the community of cyclists to feed the above mentioned information into a system, and have that information continually updated and rated by all of the community members. Having a social route rating application for mobile computing devices to be used by riders, would provide an easily accessible and rich source of meta-data about bike routes, which will help bike riders in choosing the best route for their ride based on their needs, whether it be for work or recreation. In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the social platform for providing route ratings in the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of a social application for capturing and providing route information may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

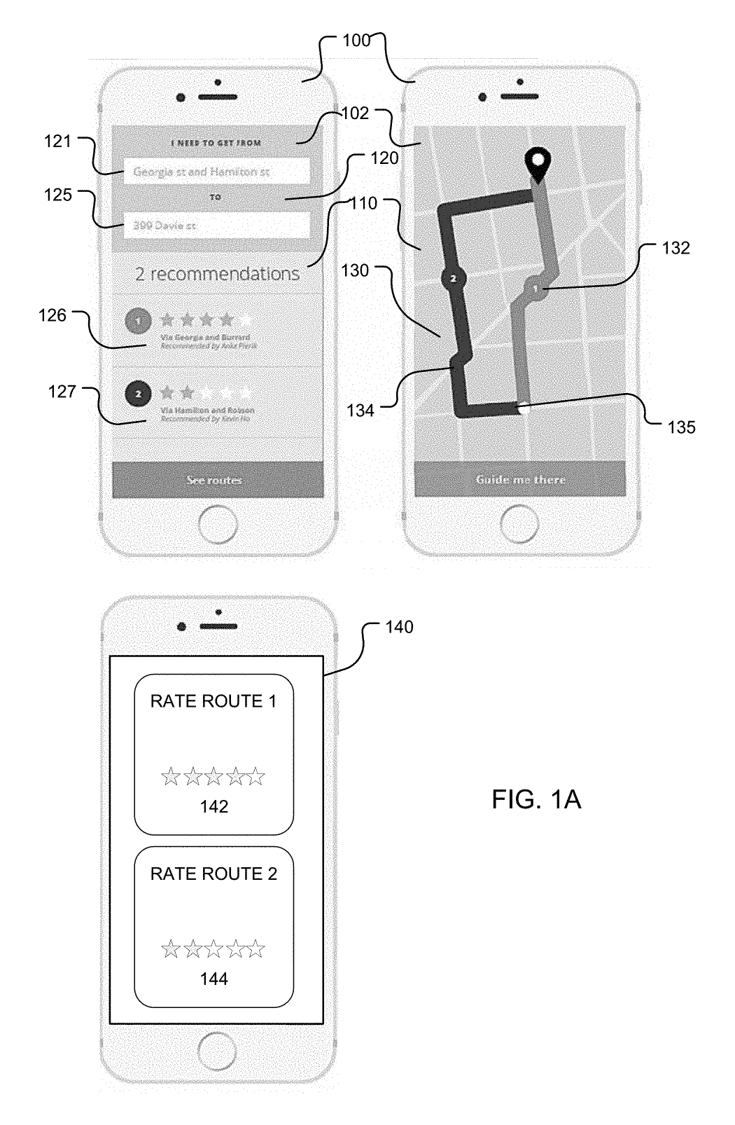

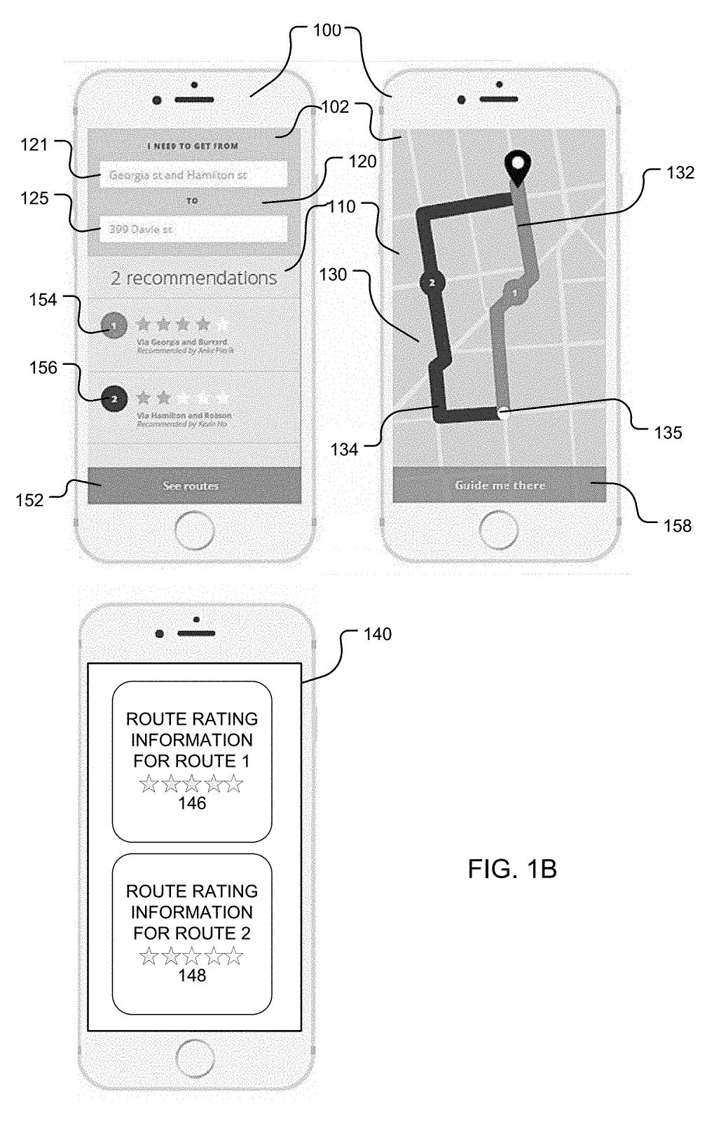

FIG. 1A illustrates an example of a mobile device having a social route rating application running thereon. As illustrated in the figure, a mobile computing device 100 may comprise a display 102, which may also be a touch screen for receiving user inputs thereby. A social route rating application 110 is displayed on the display 102. A first screen 120 generated by the application 110 may be configured to solicit and receive route information from a community member using the application. As shown in the figure, an information provider may designate a beginning position 121, such as a current location or other starting point, and a destination 125. The social rating platform may then generate possible or suggested routes to be rated by the information provider, and solicit ratings 126, 127 for each of the routes. The information provider may then rate the route they have knowledge about or has just traversed by tapping or touching the ratings or reviews, which will then take the user to a third screen 140. On the third screen 140, the user may add his or her own rating information 142, 144 about a particular route into the application 110. It will be appreciated that the rating information 142, 144 may include, but is not limited to, route safety, bike parking location, route descriptions, bike traffic, pedestrian versus rider density, route quality, bike-related incidents/accidents along the route, topography, air quality and other similar information.

Additionally, a second screen 130 may be generated by the application 110 that would provide possible routes 132, 134 to a designated destination 135, 125 for a user that is an information consumer. The social route rating platform may also provide ratings for those routes that were provided by a community member through the first screen 120 of the mobile route rating application 110.

FIG. 1B illustrates an example of a mobile device having a social route rating application running thereon to facilitate the selection of a route to a destination by a user. After the first screen 120 is generated by the application 110 and the user has input the beginning position 121 and the destination 125, the application will provide route information. As discussed herein, the route information may be provided based on bike-specific information such as route safety, proximity to public transportation, bike parking locations, route descriptions, route traffic, route quality, accidents along the route, air quality, and the like. This information is used by bike riders to plan and select routes based on their particular needs and preferences.

It will be appreciated that a user may initiate a selection process for a desired route by tapping or touching a “See Routes” button 152 from the first screen 120 generated by the application 110, which may be configured to solicit and receive a route selection from a community member using the application. Upon tapping or touching the button 152, the application 110 may direct the user to the second screen 130 providing possible routes 132, 134 to a designated destination 135, 125 for a user. In an implementation, the user may directly select a desired route from the first screen 120 by tapping or touching one of the presented route options 154, 156, which will then take the user to a screen showing the route details and route data for the user to follow the selected route.

Upon tapping or touching the button 152, the user is then able to select which route is desired by tapping or touching the desired route from the second screen 130, which will then take the user directly to a screen showing the route details and route data for the user to follow the selected route. Alternatively, after the user selects the desired route, the user may then tap or touch the “Guide Me There” button 158, which will then take the user directly to a screen showing the route details and route data for the user to follow the selected route.

It will be appreciated that a user who wants to select a route based on the route rating information 146, 148 may access one of the screens, such as the third screen 140, wherein the user is provided with the route rating information 146, 148. The user can use the route rating information 146, 148 and other information provided by the application 110 to help the user select a desired route. The user may then select the route based on the route rating information 146, 148.

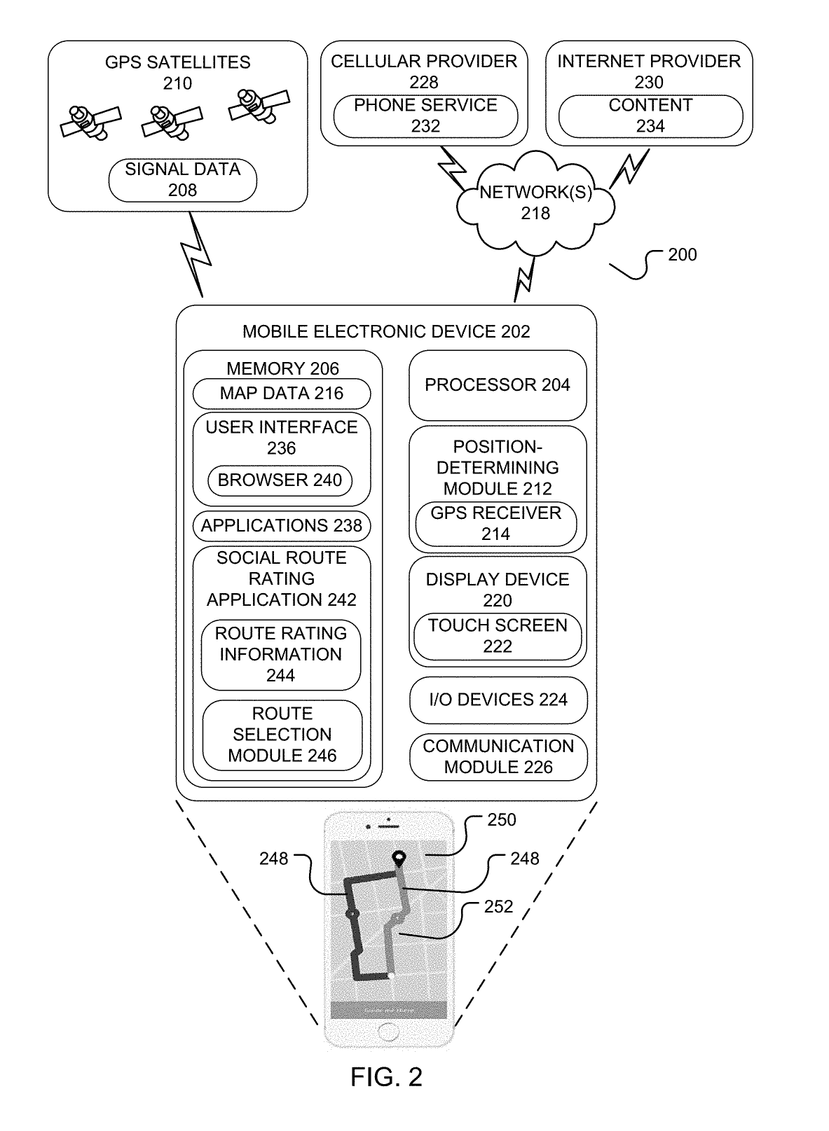

In FIG. 2, a mobile electronic device 202 is illustrated as including a processor 204 and a memory 206. The processor 204 provides processing functionality for the mobile electronic device 202 and may include any number of processors, micro-controllers, or other processing systems, and resident or external memory for storing data and other information accessed or generated by the mobile electronic device 202. The processor 204 may execute one or more software programs that implement the techniques and modules described herein. The processor 204 is not limited by the materials from which it is formed or the processing mechanisms employed therein and, as such, may be implemented via semiconductor(s) and/or transistors (e.g., electronic integrated circuits (ICs)), and so forth.

The memory 206 is an example of device-readable storage media that provides storage functionality to store various data associated with the operation of the mobile electronic device 202, such as the software program and code segments mentioned above, or other data to instruct the processor 204 and other elements of the mobile electronic device 202 to perform the techniques described herein. Although a single memory 206 is shown, a wide variety of types and combinations of memory may be employed. The memory 206 may be integral with the processor 204, stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth.

The mobile electronic device 202 is further illustrated as including functionality to determine position. For example, the mobile electronic device 202 may receive signal data 208 transmitted by one or more position data platforms and/or position data transmitters, examples of which are depicted as the GPS satellites 210. More particularly, mobile electronic device 202 may include a position-determining module 212 that may manage and process signal data 208 received from Global Positioning System (GPS) satellites 210 via a GPS receiver 214. The position-determining module 212 is representative of functionality operable to determine a geographic position through processing of the received signal data 208. The signal data 208 may include various data suitable for use in position determination, such as timing signals, ranging signals, ephemerides, almanacs, and so forth.

Position-determining module 212 may also be configured to provide a variety of other position-determining functionality. Position-determining functionality, for purposes of discussion herein, may relate to a variety of different navigation techniques and other techniques that may be supported by “knowing” one or more positions. For instance, position-determining functionality may be employed to provide position/location information, timing information, speed information, and a variety of other navigation-related data. Accordingly, the position-determining module 212 may be configured in a variety of ways to perform a wide variety of functions. For example, the position-determining module 212 may be configured for outdoor navigation, vehicle navigation, personal use (e.g., as a part of fitness-related equipment), and so forth. Accordingly, the position-determining module 212 may include a variety of devices to determine position using one or more of the techniques previously described.

The mobile electronic device 202 may include one or more antennas to receive signal data 208 as well as to perform other communications, such as communication via one or more networks 218 described in more detail below. It should be apparent that a wide variety of other positioning systems may also be employed, such as other global navigation satellite systems (GNSS), terrestrial based systems (e.g., wireless-phone based systems that broadcast position data from cellular towers), wireless networks that transmit positioning signals, and so on. For example, positioning-determining functionality may be implemented through the use of a server in a server-based architecture, from a ground-based infrastructure, through one or more sensors (e.g., gyros, odometers, and magnetometers), use of “dead reckoning” techniques, and so on.

The mobile electronic device 202 includes a display device 220 to display information to a user of the mobile electronic device 202. In embodiments, the display device 220 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display device 220 may be backlit via a backlight such that it may be viewed in the dark or other low-light environments.

The display device 220 may be provided with a touch screen 222 to receive input (e.g., data, commands, etc.) from a user. For example, a user may operate the mobile electronic device 202 by touching the touch screen 222 and/or by performing gestures on the screen 222. In some embodiments, the touch screen 222 may be a capacitive touch screen, a resistive touch screen, an infrared touch screen, combinations thereof, and the like. The mobile electronic device 202 may further include one or more input/output (I/O) devices 224 (e.g., a keypad, buttons, a wireless input device, a thumbwheel input device, a trackstick input device, and so on). The I/O devices 224 may include one or more audio I/O devices, such as a microphone, speakers, and so on.

The mobile electronic device 202 may also include a communication module 226 representative of communication functionality to permit mobile electronic device 202 to send/receive data between different devices (e.g., components/peripherals) and/or over the one or more networks 218. Communication module 226 may be representative of a variety of communication components and functionality including, but not limited to: one or more antennas; a browser; a transmitter and/or receiver; a wireless radio; data ports; software interfaces and drivers; networking interfaces; data processing components; and so forth.

The one or more networks 218 are representative of a variety of different communication pathways and network connections which may be employed, individually or in combinations, to communicate among the components of the environment 200. Thus, the one or more networks 218 may be representative of communication pathways achieved using a single network or multiple networks. Further, the one or more networks 218 are representative of a variety of different types of networks and connections that are contemplated including, but not limited to: the Internet; an intranet; a satellite network; a cellular network; a mobile data network; wired and/or wireless connections; and so forth.

Examples of wireless networks include, but are not limited to: networks configured for communications according to: one or more standard of the Institute of Electrical and Electronics Engineers (IEEE), such as 802.11 or 802.16 (Wi-Max) standards; Wi-Fi standards promulgated by the Wi-Fi Alliance; Bluetooth standards promulgated by the Bluetooth Special Interest Group; and so on. Wired communications are also contemplated such as through universal serial bus (USB), Ethernet, serial connections, and so forth.

The mobile electronic device 202 through functionality represented by the communication module 226 may be configured to communicate via one or more networks 218 with a cellular provider 228 and an Internet provider 230 to receive mobile phone service 232 and various content 234, respectively. Content 234 may represent a variety of different content, examples of which include, but are not limited to: map data, which may include route information; web pages; services; music; photographs; video; email service; instant messaging; device drivers; real-time and/or historical weather data; instruction updates; and so forth.

The mobile electronic device 202 is illustrated as including a user interface 236, which is storable in memory 206 and executable by the processor 204. The user interface 236 is representative of functionality to control the display of information and data to the user of the mobile electronic device 202 via the display device 220. In some implementations, the display device 220 may not be integrated into the mobile electronic device and may instead be connected externally using universal serial bus (USB), Ethernet, serial connections, and so forth. The user interface 236 may provide functionality to allow the user to interact with one or more applications 238 of the mobile electronic device 202 by providing inputs via the touch screen 222 and/or the I/O devices 224. For example, the user interface 236 may cause an application programming interface (API) to be generated to expose functionality to an application 238 to configure the application for display by the display device 220 or in combination with another display. In embodiments, the API may further expose functionality to configure the application 238 to allow the user to interact with an application by providing inputs via the touch screen 222 and/or the I/O devices 224.

Applications 238 may comprise software, which is storable in memory 206 and executable by the processor 204, to perform a specific operation or group of operations to furnish functionality to the mobile electronic device 202. Example applications may include fitness application, exercise applications, health applications, diet applications, cellular telephone applications, instant messaging applications, email applications, photograph sharing applications, calendar applications, address book applications, and so forth.

The mobile electronic device 202 is illustrated as including a social route rating application 242, which is storable in memory 206 and executable by the processor 204. The social route rating application 242 represents functionality to access map data 216 that is stored in the memory 206 to provide mapping and navigation functionality to the user of the mobile electronic device 202. For example, the social route rating application 242 may generate navigation information that includes maps and/or map-related content for display by display 220. As used herein, map related content includes information associated with maps generated by the social route rating application 242 and may include route information, POIs, information associated with POIs, map legends, controls for manipulation of a map (e.g., scroll, pan, etc.), street views, aerial/satellite views, and the like, displayed on or as a supplement to one or more maps.

In one or more implementations, the social route rating application 242 is configured to utilize the map data 216 to generate route rating information 244 that includes information from community members regarding route characteristics for display by the mobile electronic device 202 independently of content sources external to the mobile electronic device 202. Thus, for example, the social route rating application 242 may be capable of providing mapping and navigation functionality when access to external content 234 is not available through network 218. It is contemplated; however, that the navigation module 242 may also be capable of accessing a variety of content 234 via the network 218 to generate navigation information including maps and/or map-related content for display by the mobile electronic device 202 in one or more implementations.

The social route rating application 242 may be configured in a variety of ways. For example, the social route rating application 242 may be configured as an application 238 accessed by the user interface 236. The social route rating application 242 may utilize position data determined by the position-determining module 212 to show a current position of the user (e.g., the mobile electronic device 202) on a displayed map, furnish navigation instructions (e.g., turn-by-turn instructions to an input destination or POI), calculate traveling distances and times, and so on.

In implementations, the user interface 236 may include a browser 240. The browser 240 enables the mobile electronic device 202 to display and interact with content 234 such as a webpage within the World Wide Web, a webpage provided by a web server in a private network, and so forth. The browser 240 may be configured in a variety of ways. For example, the browser 240 may be configured as an application 238 accessed by the user interface 236. The browser 240 may be a web browser suitable for use by a full resource device with substantial memory and processor resources (e.g., a smart phone, a personal digital assistant (PDA), etc.). However, in one or more implementations, the browser 240 may be a mobile browser suitable for use by a low-resource device with limited memory and/or processing resources (e.g., a mobile telephone, a portable music device, a transportable entertainment device, etc.). Such mobile browsers typically conserve memory and processor resources, but may offer fewer browser functions than web browsers.

As illustrated in FIG. 2, the social route rating application 242 further includes a route selection module 246, which is also storable in memory 206 and executable by the processor 204. The route selection module 246 causes the display 220 of the mobile electronic device 202 to be configured to display route selection information 248. In the implementation shown, the route selection information 248 is illustrated in the format of a map page 250 that includes a route graphic 252 representing a route that may be traversed by a user of the mobile electronic device 202 (e.g., by the user, by a vehicle (e.g., a bicycle) operated by the user in or on which the mobile electronic device 202 is mounted or carried or some combination thereof). The route describes a path that the user may traverse from a starting point to a destination. In an implementation, the starting point may be a geographic position determined by the position-determining module 212 of the device 202, such as the current geographic location of the device 202. However, the starting point may also be manually designated by the user through the user interface 236. As discussed herein below, the route selection module 246 further includes functionality to cause the display device 220 to, sequentially or simultaneously, display additional route graphics 252 for one or more alternate routes (e.g., a second route, a third route, and so forth) that may also be traversed by the user to the same destination point. The route represented by each route graphic 252 can comprise, without limitation, any navigable path, trail, road, lane, street, pike, highway, tollway, freeway, interstate highway, sidewalk, combinations thereof, or the like, that may be traversed by a user of the mobile electronic device 202.

The route selection module 246 may include functionality (or may invoke functionality provided by the social route rating application 242) to generate one or more routes to a destination from a starting point. These routes may, for example, be generated using map data 216 stored in memory 206 of the device 202.

In at least some instances, the starting point may be the current geographic position of the mobile electronic device 202 determined by the position determining module 212. However, it is contemplated that the starting point may be input by the user of the mobile electronic device via the display device 220 and touch screen 222 and/or I/O devices 224. Similarly, the destination may be entered or selected by the user of the mobile electronic device 202. The destination may be entered as latitude/longitude information associated with a location, an address, a POI, a user-selected point (e.g., user selects a desired destination point via the touch screen 222) on a map displayed by the display device 220, a destination selected from content 234 received via the communication module 226 and/or stored in memory 206 by the mobile electronic device 202 (e.g., a webpage, an email, a text message, a photograph, etc.), and so on.

In some configurations, the route selection module 246 may select possible routes using historical route information provided by social community members and stored within a local route database on the device 202 and/or accessible through a remote route database using the communication module 226. The route database(s) may include a plurality of previously-traversed routes that may be searched, indexed, compiled, analyzed, or otherwise selected for travel by the user. Based on the current position, or another designated starting point, the route selection module 246 may identify stored routes that include or otherwise relate to the designated starting point. These corresponding stored routes may be presented to the user, in addition to or as an alternative to the calculated routes discussed above, for review and selection. For example, the corresponding routes accessed from the route database may include ratings for: a difficult route starting at the current location, a short route ending at the current location, a long route including the current location, a scenic route including a user designated location, a composite route generated from one or more rated routes corresponding to the current location.

The presentation of the rated and stored routes will include rates derived from the community data such as user ratings and comments regarding the stored routes, user ratings, etc.

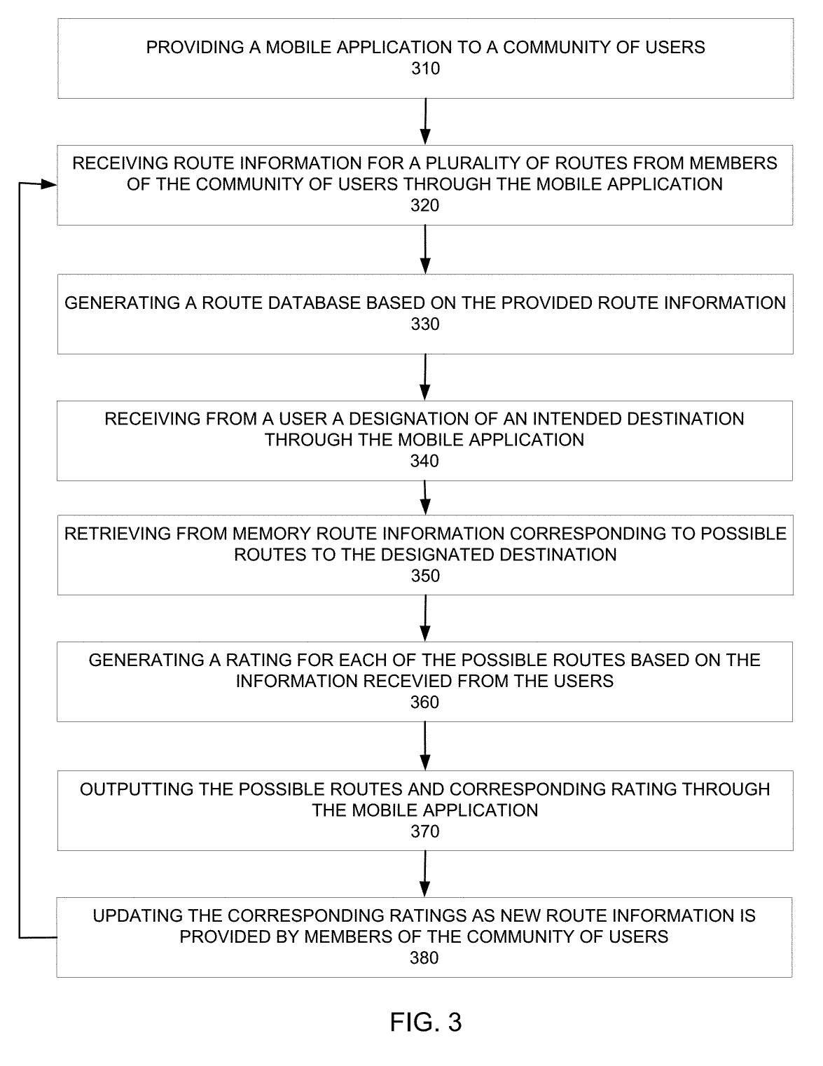

FIG. 3 illustrates an implementation of a method and system for rating route specific information in a social platform. The platform may comprise a mobile social application that connects a plurality of community members to a route rating system over a network. As used herein a social application is intended to represent a computer and computer network based community of users/members that have a common interest. In the present disclosure, the common interest is commuting or traveling over designated public routes, and most often cycling over those public routes. At 310, the platform may provide a mobile application to the community of users, and through the present mobile application the platform may solicit information from experienced members. For example, in an implementation, a user (such as a commuter) who has the mobile application may be solicited for a rating of the route that the user has just traveled. Additionally, the mobile application may allow a user to manually select routes for which to enter information.

At 320, the platform may receive route information for a route or a plurality of routes from members of the community of users through the mobile application, and at 330 may generate a route database that is based on the provided route information. The database may comprise route information such as member ratings, safety, construction, pedestrian traffic, traffic times, auto traffic, cyclist traffic, lighting conditions, exercise level, scenic value, travel time, public transit access along the route, etc.

At 340, the platform may receive a designation of an intended destination, or intended route, through the mobile application. For example, a consuming member user may use the application to decide on which route is best for his/her specific needs. The user may be seeking a good commuting route, such as the quickest commuting route or the commuting route with the least amount of traffic among other factors, or the user may be seeking more scenic route options. Accordingly, an implementation may allow the user to designate its intentions for the route, and the platform may suggest a plurality of routes based on such route characteristics as scenic, exercise, and commutability.

At 350, the platform may retrieve route information from the route database that corresponds to possible routes to the designated destination.

At 360, the platform may generate a rating for each of the possible routes based on the information received from the providing users, and at 370, the platform may output the possible routes and corresponding rating through the mobile application to the consuming member. As discussed above, the output may include selectable route possibilities along with various ratings. For example, the output may include an overall rating for a route, or may have detailed ratings for the characteristics of the route noted above.

At 380, the platform may update the corresponding ratings of routes as new route information is provided by members of the community.

In an implementation, the platform may focus on the needs of specific users such as tourists, rental car companies, delivery service individuals, to name a few. Additionally, as part of the social nature of the platform, these focused users may freely add to the route rating database, or may be restricted from providing information.

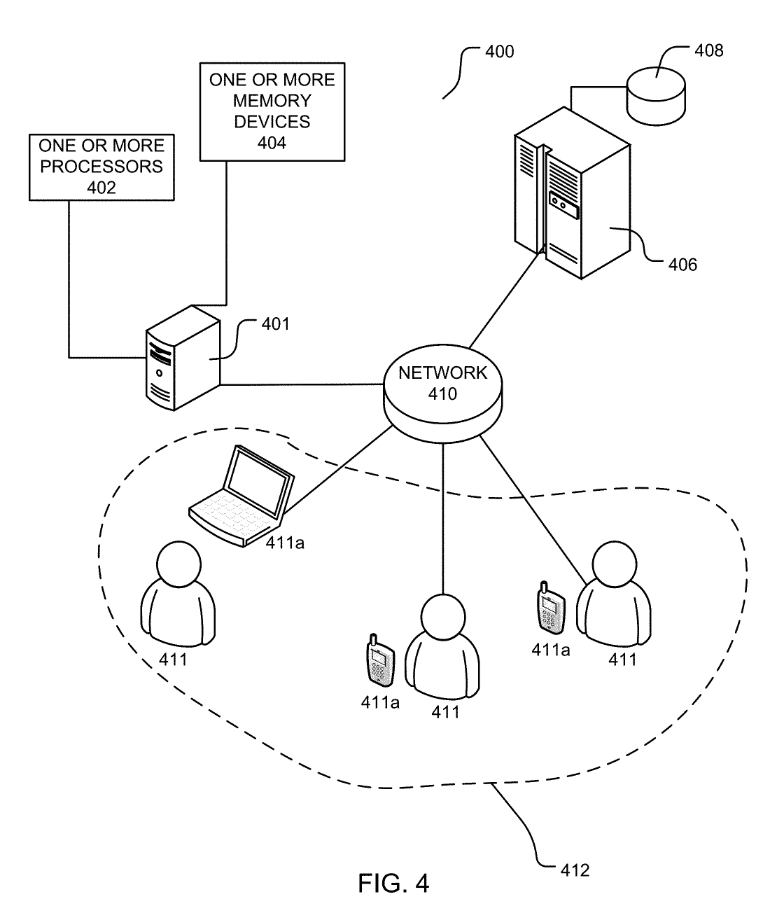

Referring now to FIG. 4, there is illustrated a system for rating routes. The system 400 may comprise one or more processors 402 and one or more memory devices 404 operably coupled to the one or more processors 402 and storing executable and operational data. It will be appreciated that a computing device 401 may comprise the one or more processors 402 and one or more memory devices 404. The system 400 may further comprise a route server 406 having a route database 408 comprising route information submitted by providing users of a social community. The route database may comprise route ratings from users of the social community. The system 400 may also comprise a social platform 412 that provides electronic communication between community members 411 of the social community over one or more networks 410. The social platform may include a social route rating application for a mobile computing device configured to: provide a mobile application to a community of users; receive route information for a plurality of routes from providing users of the community of users through the mobile application; generate a route database based on the provided route information; receive from a consuming user a designation of an intended destination through the mobile application; retrieve from the route database route information corresponding to possible routes to the designated destination; generate a rating for each of the possible routes based on the information received from the providing users; and output the possible routes and corresponding rating through the mobile application.

The social platform 412 may further comprise updating the corresponding ratings as new route information is provided by providing users of the community.

The system 400 may further comprise a mobile electronic device 411a having a position-determining module that manages and processes signal data received from Global Positioning System (GPS) satellites via a GPS receiver.

The system 400 may further comprise a route selection module, which may be storable in memory and executable by the processor. The route selection module may cause the display of the mobile electronic device to be configured to display route information. The route information may comprise route automobile traffic or route pedestrian traffic. The route information may comprise proximity to public transit or route quality. The route information may also comprise accidents along the route and other information.

In an implementation, the platform may communicate directly with personal GPS units, and may be provided in connection with rental cars.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for rating routes comprising:
receiving route information for a plurality of routes from a community of users through a mobile application and storing the route information in computer memory;
generating a route database based on the provided route information;
receiving from a consuming user a designation of an intended destination through the mobile application;
retrieving from computer memory route information corresponding to possible routes to the designated destination;
generating a rating for each of the possible routes based on the information received from the community of users; and
outputting the possible routes and corresponding rating through the mobile application.

2. The method of claim 1, further comprising updating the corresponding ratings as new route information is provided by the community of users.

3. The method of claim 1, wherein the route information comprises cycling specific information.

4. The method of claim 1, wherein the route information comprises automobile specific information.

5. The method of claim 1, wherein the route information comprises route safety.

6. The method of claim 1, wherein the route information comprises route automobile traffic.

7. The method of claim 1, wherein the route information comprises route pedestrian traffic.

8. The method of claim 1, wherein the route information comprises proximity to public transit.

9. The method of claim 1, wherein the route information comprises route quality.

10. The method of claim 1, wherein the route information comprises accidents along the route.

11. A system for rating routes comprising: one or more processors and one or more memory devices operably coupled to the one or more processors and storing executable and operational data, the system further comprising:
a route server having a route database comprising route information submitted by providing users of a social community;
wherein the route database comprises route ratings;
a social platform that provides electronic communication between community members of the social community;
a social route rating application configured to:
provide a mobile application to a community of users;
receive route information for a plurality of routes from providing users of the community of users through the mobile application;
generate a route database based on the provided route information;
receive from a consuming user a designation of an intended destination through the mobile application;
retrieve from the route database route information corresponding to possible routes to the designated destination;
generate a rating for each of the possible routes based on the information received from the providing users; and
output the possible routes and corresponding rating through the mobile application.

12. The system of claim 11, wherein the social platform further comprises updating the corresponding ratings as new route information is provided by providing users of the community.

13. The system of claim 11, further comprising a mobile electronic device having a position-determining module that manages and processes signal data received from Global Positioning System (GPS) satellites via a GPS receiver.

14. The system of claim 11, further comprising a route selection module.

15. The system of claim 11, wherein the route information comprises route automobile traffic.

16. The system of claim 11, wherein the route information comprises route pedestrian traffic.

17. The system of claim 11, wherein the route information comprises proximity to public transit.

18. The system of claim 11, wherein the route information comprises route quality.

19. The system of claim 11, wherein the route information comprises accidents along the route.

20. A method for rating route specific information comprising:
receiving a designation of a route through a social application from a community of members;
receiving route information for the designated route from a providing member;
receiving a destination inquiry corresponding to the route from a consuming member;
generating a rating for the route based on the route information; and
outputting the designated route and rating to the consuming member through the social application.
